(19) United States
(12) Patent Application Publication
(10) Pub. No.: US 2021/0187613 A1
(43) Pub. Date: Jun. 24, 2021

(54) MANUFACTURING SYSTEM AND METHOD FOR PROVIDING VARIABLE PRESSURE ENVIRONMENT

(71) Applicant: BEIJING INSTITUTE OF TECHNOLOGY, Beijing (CN)

(72) Inventors: Zhijing ZHANG, Beijing (CN); Muzheng XIAO, Beijing (CN); Jiangzhou SU, Beijing (CN); Zhipeng YE, Ghaungzhou (CN); Xin JIN, Beijing (CN); Yichong YANG, Beijing (CN)

(73) Assignee: BEIJING INSTITUTE OF TECHNOLOGY, Beijing (CN)

(21) Appl. No.: 16/080,132

(22) PCT Filed: Oct. 11, 2017
(86) PCT No.: PCT/CN2017/105591

§ 371 Date: Aug. 27, 2018

(51) Int. Cl. B22F 10/20; B22F 3/105

(52) U.S. Cl. CPC B22F 10/20; B22F 10/30; B22F 3/105

(57) ABSTRACT

Various examples of the present disclosure provide a manufacturing system and method for providing a variable pressure environment, which are applied to additive manufacturing and subtractive manufacturing, such as metal-based additive and subtractive manufacturing, hybrid additive and subtractive manufacturing, or ultrasonic hybrid additive manufacturing, etc. According to the examples of the present disclosure, a variable pressure environment is provided within the seal pressure vessel so as to implement the manufacturing process in the hyperbaric pressure environment. Thus, for a manufacturing process using metals as raw materials, various issues caused by metallurgical defects of the metals can be effectively suppressed. The storage vessel of the inert gas is safe and stable to the hyperbaric pressure environment, so that a manufacturing process applying a continuous and uniform hyperbaric pressure is achieved. In addition, the examples of the present disclosure perform temperature control on the hyperbaric pressure environment to ensure temperature stability of the hyperbaric pressure environment. Moreover, a solid self-lubrication mode is used in the manufacturing system, so as to avoid oil and grease lubrication from splashing in the vacuum environment to pollute the manufacturing environment, and thus the manufacturing system can work normally in the hyperbaric pressure environment.

### PRIORITY DECLARATION

The present application claims the priority of an International Patent Application No. PCT/CN2017/105591, entitled “MANUFACTURING SYSTEM AND METHOD FOR PROVIDING VARIABLE PRESSURE ENVIRONMENT”, filed on Oct. 11, 2017, the disclosures of which are incorporated herein by reference.

### FIELD OF THE INVENTION

The present disclosure relates to manufacturing technology, and more particularly, to a manufacturing system and method for providing a variable pressure environment, which are applied to additive manufacturing (AM), subtractive manufacturing (e.g., a machining process), or hybrid additive and subtractive manufacturing.

### BACKGROUND OF THE INVENTION

Additive manufacturing technology is a kind of manufacturing technology emerged and rapidly developed in recent years. The field of additive manufacturing using metals as raw materials especially gets more attention due to its potential of directly and rapidly prototyping an engineering part.

The additive manufacturing using metals as raw materials may manufacture a part with a complex shape. The basic principle is that the raw materials (such as metal powder, metal wire, etc.) are melted into a liquid state or a semi-solid state through a heating source (such as laser, arc, ion beam, electron beam, etc.), then the liquid or semi-solid raw materials are deposited layer by layer according to a pre-generated slicing path corresponding to a target shape of the part.

Due to metallurgical defects of the metals, the part obtained through the additive manufacturing tends to have defects such as pores, micro cracks, etc. In addition, there are a large amount of residual stress in the part obtained through the additive manufacturing. Due to the above-mentioned defects and residual stress, the part is easily deformed and cracked, and has insufficient strength. As such, the part obtained through the additive manufacturing is difficult to be applied to actual projects.

In order to cure the above-mentioned deficiencies of the additive manufacturing, the prior art proposes a method of implementing additive manufacturing under a hyperbaric pressure environment. Stability of the hyperbaric pressure environment is required for implementation of this method. However, a conventional apparatus used for the additive manufacturing cannot implement stability control to the hyperbaric pressure environment.

### SUMMARY OF THE INVENTION

According to an example of the present disclosure, a manufacturing system for providing a variable pressure environment includes:

a seal pressure vessel;

a monitoring apparatus, to monitor an environmental parameter in the seal pressure vessel;

a manufacturing apparatus, wherein the manufacturing apparatus is located in the seal pressure vessel;

a vacuum pump, wherein the vacuum pump is connected with the seal pressure vessel;

a first inert gas source;

a storage vessel of inert gas, wherein the storage vessel of the inert gas is connected with the first inert gas source and the seal pressure vessel respectively;

a computer numerical control (CNC) system, to control the vacuum pump to vacuumize the seal pressure vessel before the manufacturing apparatus performs manufacturing operations, control, according to feedback of the monitoring apparatus and after the seal pressure vessel is vacuum, the first inert gas source to inject the inert gas into the seal pressure vessel through the storage vessel of the inert gas until a pressure in the seal pressure vessel reaches a hyperbaric pressure, and control, according to the feedback of the monitoring apparatus, the storage vessel of the inert gas to implement dynamic compensation for a positive deviation or a negative deviation of the pressure in the seal pressure vessel compared with a target pressure.

According to another example of the present disclosure, a manufacturing method for providing a variable pressure environment includes:

at step a1, controlling a vacuum pump to vacuumize a seal pressure vessel;

at step a2, controlling a first inert gas source to inject inert gas into the seal pressure vessel in a vacuum state through a storage vessel of the inert gas until a pressure in the seal pressure vessel reaches a hyperbaric pressure;

at step a3, performing a manufacturing process in the seal pressure vessel that is under the hyperbaric pressure;

at step a4, releasing the hyperbaric pressure in the seal pressure vessel;

at step a5, taking out a manufactured part from the seal pressure vessel;

wherein when at least one of the step a2 and step a3 is performed, the method further includes:

at step b1, controlling the storage vessel of the inert gas to implement dynamic compensation for a positive deviation or a negative deviation of the pressure in the seal pressure vessel compared with a target pressure.

### BRIEF DESCRIPTION OF DRAWINGS

FIG. 1 is a schematic diagram illustrating structure of a manufacturing system, according to an example of the present disclosure;

FIG. 2 is a schematic flowchart illustrating a manufacturing method, according to another example of the present disclosure.

### DETAILED DESCRIPTION OF THE INVENTION

To make the objective, technical solution, and advantages of the present disclosure more clearly, examples of the present disclosure are described in detail with reference to the accompanying drawings.

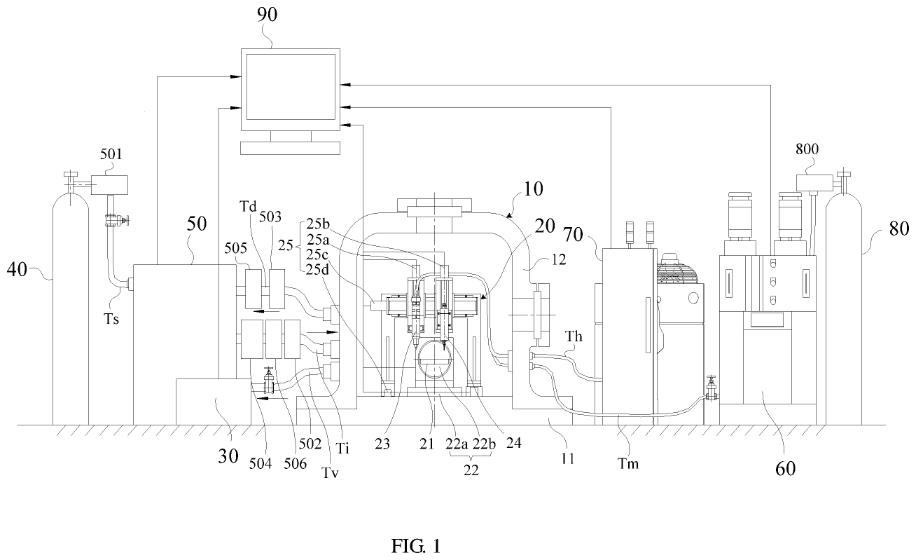

Referring to FIG. 1, according to an example of the present disclosure, a manufacturing system for providing a variable pressure environment may at least implement the additive manufacturing. The manufacturing system includes a seal pressure vessel 10, a manufacturing apparatus 20, a vacuum pump 30, an inert gas source 40, a storage vessel of inert gas 50, a feeding apparatus 60, a heating source 70, an inert gas source 80, and a computer numerical control (CNC) system 90.

Pressure resistance of the seal pressure vessel 10 is within the range between vacuum and 100 bar, in which 1 bar=10⁵ Pascal (Pa). For example, the pressure resistance of the seal pressure vessel 10 may be not less than 60 bar.

In addition, a monitoring apparatus (not shown in the figure) is configured in the seal pressure vessel 10, such as a pressure gauge, a thermometer, etc., for monitoring an environmental parameter in the seal pressure vessel 10 in real-time, such as a pressure, a temperature, and the like. In the example shown in FIG. 1, the seal pressure vessel 10 includes a base 11 and a cover 12 mounted on the base 11.

The manufacturing apparatus 20 is located in the seal pressure vessel 10. That is, the manufacturing apparatus 20 is located on the base 11 of the seal pressure vessel 10 and is covered with the cover 12 of the seal pressure vessel 10.

In the example shown in FIG. 1, the manufacturing apparatus 20 supports the additive manufacturing and the subtractive manufacturing, i.e., the manufacturing apparatus 20 supports the hybrid additive and subtractive manufacturing. In addition, the manufacturing apparatus 20 includes a working table 21, a rotating component 22, an additive manufacturing head 23, a subtractive manufacturing head 24, and a moving component 25.

The working table 21 has a surface for placing a workpiece. In addition, a clamp for fixing a manufactured part may be mounted on the working table 21.

The rotating component 22 includes a longitudinal turntable 22a which may rotate around a vertical axis parallel to the Z direction, and a lateral turntable 22b which may rotate around a horizontal axis parallel to the Y direction. The lateral turntable 22b is mounted on a top surface of the longitudinal turntable 22a. The working table 21 is mounted on a side surface of the lateral turntable 22b. As such, the rotating component 22 may provide the working table 21 with double rotations around the vertical axis and the horizontal axis through linkage between the longitudinal turntable 22a and the lateral turntable 22b.

In the example, the additive manufacturing head 23 uses a laser cladding head. The additive manufacturing head 23 is suspended above the working table 21.

In the example, the subtractive manufacturing head 24 uses an electric spindle that supports the machining process. The subtractive manufacturing head 24 and the additive manufacturing head 23 are suspended above the working table 21 in parallel.

The moving component 25 provides translational freedom in three directions for the additive manufacturing head 23 and the subtractive manufacturing head 24 with respect to the working table 21, in which the three directions include the X direction, the Y direction, and the Z direction.

Specifically, the moving component includes a first Z-axis 22a, a second Z-axis 22b, an X-axis 22c, and a Y-axis 22d. In this case, the additive manufacturing head 23 and the subtractive manufacturing head 24 are respectively mounted on the first Z-axis 22a and the second Z-axis 22b, so that the additive manufacturing head 23 and the subtractive manufacturing head 24 may perform Y-direction movement respectively along the first Z-axis 22a and the second Z-axis 22b. The first Z-axis 22a and the second Z-axis 22b are mounted on the X-axis 22c to cause the additive manufacturing head 23 and the subtractive manufacturing head 24 to perform X-direction movement within a manufacturing dimension range of the working table 21. The first Z-axis 22a, the second Z-axis 22b, and the X-axis 22c are integrally mounted on the Y-axis 22d through a support structure to cause the additive manufacturing head 23 and the subtractive manufacturing head 24 to perform the Y-direction movement within the manufacturing dimension range of the working table 21. The Y-axis 22d is fixed on the base of the seal pressure vessel 10.

The above-described rotating component 22, moving component 25, and subtractive manufacturing head 24 supporting the machining process use a solid lubricant medium or a non-volatile vacuum lubricant medium.

In addition, the manufacturing apparatus 20 may further include other structures such as an industrial robot (not shown in FIG. 1). In addition, the industrial robot may also use the solid lubricant medium or the non-volatile vacuum lubricant medium.

The feeding apparatus 60 is connected with the additive manufacturing head 23 in the seal pressure vessel 10 through a feeding pipeline Tm to feed raw materials to the additive manufacturing head 23. In the example shown in FIG. 1, the feeding apparatus 60 is a powder-feeding apparatus. That is, the raw materials fed by the feeding apparatus 60 are in the form of a powder. It can be understood that, as an alternative, the feeding apparatus 60 may be a wire-feeding apparatus, that is, the fed raw materials are in the form of a continuous filament.

The heating source 70 is connected with the additive manufacturing head 23 in the seal pressure vessel 10 through a heat energy pipeline Th to heat and melt the raw materials fed to the additive manufacturing head 23. A heating source provided by the heating source 70 may be a laser beam. In this case, the heat energy pipeline Th may be an optical fiber. Alternatively, the heating source provided by the heating source 70 may be an electron beam, an arc, or an ion beam. In this case, the heat energy pipe Th may be a cable.

In the example shown in FIG. 1, the vacuum pump 30 is connected with the seal pressure vessel 10 through a vacuum pipeline Tv. The storage vessel of the inert gas 50 is connected with the inert gas source 40 and the seal pressure vessel 10 respectively. That is, the storage vessel of the inert gas 50 is connected with the inert gas source 40 through a pressure-supply pipeline Ts, and is connected with the seal pressure vessel 10 through a pressure-increasing pipeline Ti and a pressure-decreasing pipeline Td. In this case, a gas booster pump 506 is configured in the pressure-increasing pipeline Ti.

The CNC system 90 controls the vacuum pump 30 to vacuumize the seal pressure vessel 10 before the manufacturing apparatus 20 performs manufacturing operations, and closes the vacuum pipeline Tv after the seal pressure vessel 10 is vacuum. The computer numerical control system 90 also controls, according to feedback of the monitoring apparatus and after the seal pressure vessel 10 is vacuum, the inert gas source 40 to inject inert gas into the seal pressure vessel 10 through the storage vessel of the inert gas 50 until the pressure in the seal pressure vessel 10 reaches a hyperbaric pressure, e.g., 5 MPa. And, the CNC system 90 controls, according to the feedback of the monitoring apparatus, the storage vessel of the inert gas 50 to implement dynamic compensation for a positive deviation or a negative deviation of the pressure in the seal pressure vessel 10 compared with a target pressure.

For a situation where a hyperbaric pressure environment is formed, the above-mentioned target pressure may be a fixed value representing a standard pressure of the hyperbaric pressure environment. For a pressure-increasing process forming the hyperbaric pressure environment, the above-mentioned target pressure may be a variable representing a desired pressure-increasing trend.

The positive deviation or the negative deviation means that the pressure in the seal pressure vessel 10 may be higher than the target pressure, or may be lower than the target pressure. Accordingly, the compensation refers to a trend of the pressure in the seal pressure vessel 10 to change towards the target pressure.

Specifically, the above-described control implemented by the computer numerical control system 90 may be described as follows. That is, injecting of the inert gas into the storage vessel of the inert gas 50 through the pressure-supply pipeline Ts and injecting of the inert gas into the seal pressure vessel 10 through the pressure-increasing pipeline Ti are controlled by the computer numerical control system 90.

That is, the CNC system 90 may control an increment of the pressure inside the storage vessel of the inert gas 50 by controlling an amount of the inert gas injected into the storage vessel of the inert gas 50 by the pressure-supply pipeline Ts. The CNC system 90 may control an increment of the pressure inside the seal pressure vessel 10 by controlling an amount of the inert gas injected into the seal pressure vessel 10 by the pressure-increasing pipeline Ti.

In addition, opening and closing of the pressure-increasing pipeline Ti and the pressure-decreasing pipeline Td are also controlled by the CNC system 90.

For example, at a stage of creating the hyperbaric pressure environment at an initial state of the manufacturing process, the pressure-increasing pipeline Ti is opened and the pressure-decreasing pipeline Td is closed, in which only the gas booster pump 506 in the pressure-increasing pipeline Ti is allowed to inject the inert gas into the seal pressure vessel 10. During the manufacturing process, both the pressure-increasing pipeline Ti and the pressure-decreasing pipeline Td are opened, in which the gas booster pump 506 in the pressure-increasing pipeline Ti is allowed to inject the inert gas into the seal pressure vessel 10 and the pressure-decreasing pipeline Td is allowed to release the inert gas in the seal pressure vessel 10.

The release of the inert gas in the seal pressure vessel 10 performed by the pressure-decreasing pipeline Td is not controlled by the CNC system, but may be controlled by a difference of pressures between the seal pressure vessel 10 and the storage vessel of the inert gas 50. In addition, the above-described pressure-decreasing pipeline Td may further include a gas filtering apparatus 505, which is configured to filter and clean the inert gas recycled from the seal pressure vessel 10.

That is, the pressure inside the storage vessel of the inert gas 50 may not be consistent with the pressure inside the seal pressure vessel 10. As such, the difference of the pressures is allowed between the seal pressure vessel 10 and the storage vessel of the inert gas 50. Therefore, according to the difference of the pressures between the seal pressure vessel 10 and the storage vessel of the inert gas 50, an adaptive pressure-relief process may be implemented through the pressure-decreasing pipeline Td.

Specifically, referring to FIG. 1, a pressure regulating valve 501 controlled by the CNC system 90 is configured in the pressure-supply pipeline Ts. The pressure regulating valve 501 is used for controlling the amount of the inert gas injected into the storage vessel of the inert gas 50 through the pressure-supply pipeline Ts. A pressure regulating valve 502 controlled by the CNC system 90 is configured in the pressure-increasing pipeline Ti. The pressure regulating valve 502 is used for controlling of the CNC system 90 to the amount of the inert gas injected into the seal pressure vessel 10 through the pressure-increasing pipeline Ti. The gas booster pump 506 is configured in the pressure-increasing pipeline Ti. The gas booster pump 506 is configured to fill the seal pressure vessel 10 with the inert gas. A safety valve 503 is configured in the pressure-decreasing pipeline Td. The safety valve 503 is unidirectionally conducted from the seal pressure vessel 10 to the storage vessel of the inert gas 50. The safety valve 503 is configured to implement the adaptive pressure-relief process through the pressure-decreasing pipeline Td in response to the difference of the pressures between the seal pressure vessel 10 and the storage vessel of the inert gas 50.

When the pressure in the seal pressure vessel 10 forms a positive deviation compared with the target pressure, if the difference of the pressures between the storage vessel of the inert gas 50 and the seal pressure vessel 10 is sufficient to open the safety valve 503, the positive deviation may be compensated through the adaptive pressure-relief process of the seal pressure vessel 10. If the pressure inside the seal pressure vessel 10 forms a negative deviation compared with the target pressure after the adaptive pressure-relief process, an increment of the pressure for compensating the negative deviation may be generated for the seal pressure vessel 10 by injecting the inert gas into the seal pressure vessel 10 through the storage vessel of the inert gas 50.

In addition, since the seal pressure vessel 10 is full of the inert gas provided by the inert gas source 40 during the manufacturing process, when the feeding apparatus 60 is a powder-feeding apparatus, the inert gas source 80 may provide, for the feeding apparatus 60, a gas pressure used for injecting material powder. The inert gas source 80 is controlled by the CNC system 90 to be isolated from the seal pressure vessel 10 when the seal pressure vessel 10 is vacuumized. A type of the inert gas used by the inert gas sources 40 and 80 may be determined according to requirements of a manufactured part, e.g., argon, nitrogen, helium, or the like.

Based on the above example, a variable pressure environment may be provided within the seal pressure vessel 10 so as to implement the manufacturing process in the hyperbaric pressure environment. Thus, for a manufacturing process using metals as raw materials, various issues caused by metallurgical defects of the metals can be effectively suppressed. In this case, the storage vessel of the inert gas 50 is safe and stable to the hyperbaric pressure environment, so that a manufacturing process applying a continuous and uniform hyperbaric pressure may be achieved. In addition, the above-described example is universal and may be applied to metal-based additive and subtractive manufacturing, hybrid additive and subtractive manufacturing, ultrasonic hybrid additive manufacturing, etc. Further, in the above-described example, a solid lubricant medium or a non-volatile vacuum lubricant medium is used in the manufacturing system, so as to avoid oil and grease lubrication from splashing in the vacuum environment to pollute the manufacturing environment, and thus the manufacturing system can work normally in the hyperbaric pressure environment.

In addition, the above-described example may further perform temperature control on the hyperbaric pressure environment to ensure temperature stability of the hyperbaric pressure environment.

Specifically, a temperature adjusting component 504 is configured in the pressure-increasing pipeline Ti to adjust, between the storage vessel of the inert gas 50 and the pressure regulating valve 502, a temperature of the inert gas to be injected into the seal pressure vessel 10.

For example, the temperature adjusting component 504 may include cooling apparatuses connected in series between the storage vessel of the inert gas 50 and the pressure regulating valve 502. The cooling apparatuses are configured to cool the inert gas to be injected into the seal pressure vessel 10. Therefore, the temperature adjusting component 504 may also be referred to as a cooling component.

In this case, a temperature adjusting component (not shown in FIG. 1) used for heating the inert gas in the seal pressure vessel 10 may be configured in the seal pressure vessel 10, which may be referred to as a heating component, such as a preheating coil. The preheating coil may be fixed at a free position in the seal pressure vessel 10 or may be fixed below the working table 21.

Based on the above configuration, when an environment temperature inside the seal pressure vessel 10 is too high, the internal temperature of the seal pressure vessel 10 may be reduced through turning on the temperature adjusting component 504 used for cooling to inject cooled inert gas into the seal pressure vessel 10. At the same time, the storage vessel of the inert gas 50 recycles an equal amount or a basically equal amount of the inert gas from the seal pressure vessel 10 to maintain pressure balance in the seal pressure vessel 10. When the environment temperature inside the seal pressure vessel 10 is too low, the environment temperature in the seal pressure vessel 10 may be increased through a preheating coil heater.

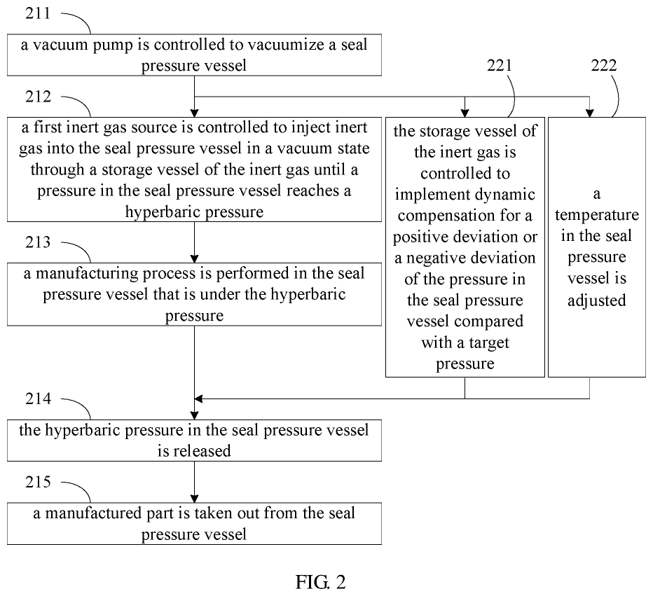

Referring to FIG. 2, in another example, a manufacturing method for providing a variable pressure environment may include operations as follows.

At block 211, a vacuum pump is controlled to vacuumize a seal pressure vessel.

At block 212, a first inert gas source is controlled to inject inert gas into the seal pressure vessel in a vacuum state through a storage vessel of the inert gas until a pressure in the seal pressure vessel reaches a hyperbaric pressure.

At block 213, a manufacturing process is performed in the seal pressure vessel that is under the hyperbaric pressure.

In this case, the operation at this step may implement additive manufacturing and/or subtractive manufacturing.

For example, at this step, the additive manufacturing may be implemented according to operations described as follows. Raw materials may be fed to the seal pressure vessel. The raw materials fed to the seal pressure vessel may be heated and melted. According to a preset path plan, additive accumulation may be performed using the melted materials. In this case, the fed metal raw materials may be in the form of a powder, and a second inert gas source may be used to provide a gas pressure for injecting raw material powder. Alternatively, the fed metal raw materials may be in the form of a continuous filament. A heating source used for the additive manufacturing at this step may be a laser beam, an electron beam, an arc, or an ion beam.

For another example, at this step, the subtractive manufacturing may be implemented by a machining process.

At block 214, the hyperbaric pressure in the seal pressure vessel is released.

At block 215, a manufactured part is taken out from the seal pressure vessel.

In the manufacturing method as shown in FIG. 2, when the operations at block 212 and block 213 are performed, the method further includes operations as follows.

At block 221, the storage vessel of the inert gas is controlled to implement dynamic compensation for a positive deviation or a negative deviation of the pressure in the seal pressure vessel compared with a target pressure.

At block 222, a temperature in the seal pressure vessel is adjusted.

The operation at block 221 may include controlling injection of the inert gas into the storage vessel of the inert gas and controlling injection of the inert gas into the seal pressure vessel. Release of the inert gas in the seal pressure vessel may be controlled by a difference of pressures between the seal pressure vessel and the storage vessel of the inert gas.

For example, a first pressure regulating valve for controlling the injection of the inert gas into the storage vessel of the inert gas may be configured between the first inert gas source and the storage vessel of the inert gas, a second pressure regulating valve for controlling the injection of the inert gas into the seal pressure vessel and a gas booster pump for injecting the inert gas into the seal pressure vessel may be configured between the storage vessel of the inert gas and the seal pressure vessel, and a safety valve for releasing the inert gas in the seal pressure vessel may be configured between the storage vessel of the inert gas and the seal pressure vessel.

When the pressure in the seal pressure vessel forms a positive deviation compared with the target pressure, if the difference of the pressures between the storage vessel of the inert gas and the seal pressure vessel is sufficient to open the safety valve, the positive deviation may be compensated through an adaptive pressure-relief process of the seal pressure vessel. If the pressure inside the seal pressure vessel forms a negative deviation compared with the target pressure after the adaptive pressure-relief process, an increment of the pressure for compensating the negative deviation may be generated for the seal pressure vessel by injecting the inert gas into the seal pressure vessel through the storage vessel of the inert gas.

In order to clean the recycled inert gas, a gas filtering apparatus may be configured between the storage vessel of the inert gas and the seal pressure vessel.

In addition, at block 222, operations of cooling the inert gas to be injected into the seal pressure vessel and heating the inert gas in the seal pressure vessel may be included.

The above are several examples of the present disclosure, and are not used for limiting the protection scope of the present disclosure. Any modifications, equivalents, improvements, etc., made under the principle and spirit of the present disclosure should be included in the protection scope of the present disclosure.

1. A manufacturing system for providing a variable pressure environment, comprising:
a seal pressure vessel;
a monitoring apparatus, to monitor an environmental parameter in the seal pressure vessel;
a manufacturing apparatus, wherein the manufacturing apparatus is located in the seal pressure vessel;
a vacuum pump, wherein the vacuum pump is connected with the seal pressure vessel;
a first inert gas source;
a storage vessel of inert gas, wherein the storage vessel of the inert gas is connected with the first inert gas source and the seal pressure vessel respectively;
a computer numerical control (CNC) system, to control the vacuum pump to vacuumize the seal pressure vessel before the manufacturing apparatus performs manufacturing operations, control, according to feedback of the monitoring apparatus and after the seal pressure vessel is vacuum, the first inert gas source to inject the inert gas into the seal pressure vessel through the storage vessel of the inert gas until a pressure in the seal pressure vessel reaches a hyperbaric pressure, and control, according to the feedback of the monitoring apparatus, the storage vessel of the inert gas to implement dynamic compensation for a positive deviation or a negative deviation of the pressure in the seal pressure vessel compared with a target pressure.

2. The system of claim 1, wherein pressure resistance of the seal pressure vessel is within a range between vacuum and 100 bar.

3. The system of claim 1, wherein the manufacturing apparatus supports additive manufacturing, subtractive manufacturing, or hybrid additive and subtractive manufacturing.

4. The system of claim 3, wherein the manufacturing apparatus comprises:
a working table, wherein the working table has a surface for placing a workpiece;
a rotating component, to provide the working table with double rotations around a vertical axis and a horizontal axis;
an additive manufacturing head, wherein the additive manufacturing head is suspended above the working table;
a subtractive manufacturing head, wherein the subtractive manufacturing head and the additive manufacturing head are suspended above the working table in parallel; and
a moving component, to provide translational freedom in three directions for the additive manufacturing head and the subtractive manufacturing head with respect to the working table.

5. The system of claim 4, further comprising:
a feeding apparatus, to feed raw materials to the additive manufacturing head; and
a heating source, to heat and melt the raw materials fed to the additive manufacturing head.

6. The system of claim 5, wherein the feeding apparatus is a powder-feeding apparatus.

7. The system of claim 6, further comprising:
a second inert gas source, to provide, for the feeding apparatus, a gas pressure used for injecting material powder, wherein the second inert gas source is controlled by the CNC system to be isolated from the seal pressure vessel when the seal pressure vessel is vacuumized.

8. The system of claim 5, wherein the feeding apparatus is a wire-feeding apparatus.

9. The system of claim 5, wherein the heating source is a laser beam, an electron beam, an arc, or an ion beam.

10. The system of claim 4, wherein the rotating component and the moving component use a solid lubricant medium or a non-volatile vacuum lubricant medium.

11. The system of claim 1, wherein the storage vessel of the inert gas is connected with the first inert gas source through a pressure-supply pipeline, and is connected with the seal pressure vessel through a pressure-increasing pipeline and a pressure-decreasing pipeline;
wherein injecting of the inert gas into the storage vessel of the inert gas through the pressure-supply pipeline and injecting of the inert gas into the seal pressure vessel through the pressure-increasing pipeline are controlled by the CNC system; and
release of the inert gas in the seal pressure vessel performed by the pressure-decreasing pipeline is controlled by a difference of pressures between the seal pressure vessel and the storage vessel of the inert gas.

12. The system of claim 11, wherein
a first pressure regulating valve controlled by the CNC system is configured in the pressure-supply pipeline;
a second pressure regulating valve controlled by the CNC system and a gas booster pump are configured in the pressure-increasing pipeline, wherein the gas booster pump is configured to fill the seal pressure vessel with the inert gas; and
a safety valve is configured in the pressure-decreasing pipeline, wherein the safety valve is unidirectionally conducted from the seal pressure vessel to the storage vessel of the inert gas.

13. The system of claim 12, wherein a gas filtering apparatus is configured in the pressure-decreasing pipeline.

14. The system of claim 12, wherein a temperature adjusting component is configured in the seal pressure vessel and/or the pressure-increasing pipeline.

15. The system of claim 14, wherein the temperature adjusting component comprises a cooling component configured in the pressure-increasing pipeline and a heating component configured in the seal pressure vessel; and
the storage vessel of the inert gas is to, controlled by the CNC system, inject the inert gas cooled by the cooling component into the seal pressure vessel and recycle the inert gas from the seal pressure vessel.

16. A manufacturing method for providing a variable pressure environment, comprising:
at step a1, controlling a vacuum pump to vacuumize a seal pressure vessel;
at step a2, controlling a first inert gas source to inject inert gas into the seal pressure vessel in a vacuum state through a storage vessel of the inert gas until a pressure in the seal pressure vessel reaches a hyperbaric pressure;
at step a3, performing a manufacturing process in the seal pressure vessel that is under the hyperbaric pressure;
at step a4, releasing the hyperbaric pressure in the seal pressure vessel;
at step a5, taking out a manufactured part from the seal pressure vessel;
wherein when at least one of the step a2 and step a3 is performed, the method further comprises:
at step b1, controlling the storage vessel of the inert gas to implement dynamic compensation for a positive deviation or a negative deviation of the pressure in the seal pressure vessel compared with a target pressure.

17. The method of claim 16, wherein the step a3 implements additive manufacturing and/or subtractive manufacturing.

18. The method of claim 17, wherein the additive manufacturing implemented by the step a3 comprises:
feeding raw materials to the seal pressure vessel;
heating and melting the raw materials fed to the seal pressure vessel; and
performing additive accumulation using the melted raw materials according to a preset path plan.

19. The method of claim 18, wherein the fed metal raw materials are in the form of a powder.

20. The method of claim 19, wherein the additive manufacturing implemented by the step a3 further comprises:
controlling a second inert gas source to provide a gas pressure for injecting raw material powder, wherein the second inert gas source is controlled to be isolated from the seal pressure vessel when the seal pressure vessel is vacuumized.

21. The method of claim 18, wherein the fed metal raw materials are in the form of a continuous filament.

22. The method of claim 18, wherein a laser beam, an electron beam, an arc, or an ion beam is used for heating and melting the raw materials.

23. The method of claim 16, wherein the step b1 comprises:
controlling injection of the inert gas into the storage vessel of the inert gas; and
controlling injection of the inert gas into the seal pressure vessel;
wherein release of the inert gas in the seal pressure vessel is controlled by a difference of pressures between the seal pressure vessel and the storage vessel of the inert gas.

24. The method of claim 16, wherein when at least one of the step a2 and step a3 is performed, the method further comprises:
at step b2, adjusting a temperature in the seal pressure vessel;
wherein the step b2 comprises:
cooling the inert gas to be injected into the seal pressure vessel and heating the inert gas in the seal pressure vessel.
